SEQUENCE LISTING (1 sequence)

SEQ ID NO: 1 - DNA, 1421 bp, Bacillus velezensis
atgcaagtcgagcggacagatgggagcttgctccctgatgttagcggcggacgggtgagtaacacgtgggtaacctgcctgtaagactgggataactccgggaaaccggggctaataccggatggttgtctgaaccgcatggttcagacataaaaggtggcttcggctaccacttacagatggacccgcggcgcattagctagttggtgaggtaacggctcaccaaggcgacgatgcgtagccgacctgagagggtgatcggccacactgggactgagacacggcccagactcctacgggaggcagcagtagggaatcttccgcaatggacgaaagtctgacggagcaacgccgcgtgagtgatgaaggttttcggatcgtaaagctctgttgttagggaagaacaagtgccgttcaaatagggcggcaccttgacggtacctaaccagaaagccacggctaactacgtgccagcagccgcggtaatacgtaggtggcaagcgttgtccggaattattgggcgtaaagggctcgcaggcggtttcttaagtctgatgtgaaagcccccggctcaaccggggagggtcattggaaactggggaacttgagtgcagaagaggagagtggaattccacgtgtagcggtgaaatgcgtagagatgtggaggaacaccagtggcgaaggcgactctctggtctgtaactgacgctgaggagcgaaagcgtggggagcgaacaggattagataccctggtagtccacgccgtaaacgatgagtgctaagtgttagggggtttccgccccttagtgctgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcctctgacaatcctagagataggacgtccccttcgggggcagagtgacaggtggtgcatggttgtcgtcagctcgtgtcgtgagatgttgggttaagtcccgcaacgagcgcaacccttgatcttagttgccagcattcagttgggcactctaaggtgactgccggtgacaaaccggaggaaggtggggatgacgtcaaatcatcatgccccttatgacctgggctacacacgtgctacaatggacagaacaaagggcagcgaaaccgcgaggttaagccaatcccacaaatctgttctcagttcggatcgcagtctgcaactcgactgcgtgaagctggaatcgctagtaatcgcggatcagcatgccgcggtgaatacgttcccgggccttgtacacaccgcccgtcacaccacgagagtttgtaacacccgaagtcggtgaggtaacctttatggagccagccgccg

(19) United States
(12) Patent Application Publication
(10) Pub. No.: US 2019/0261633 A1
(43) Pub. Date: Aug. 29, 2019

(54) TYPE OF BACILLUS VELEZENSIS AND ITS APPLICATIONS IN PLANTS

(71) Applicants: Zhijun Lu, Beijing (CN); Peng Li, Beijing (CN); Wangpeng Shi, Beijing (CN); Yongmei Tao, Beijing (CN); Tao Zhang, Beijing (CN)

(72) Inventors: Zhijun Lu, Beijing (CN); Peng Li, Beijing (CN); Wangpeng Shi, Beijing (CN); Yongmei Tao, Beijing (CN); Tao Zhang, Beijing (CN)

(21) Appl. No.: 16/124,399

(22) Filed: Sep. 7, 2018

(30) Foreign Application Priority Data
Sep. 8, 2017 (CN) 2017108100139

(51) Int. Cl. A01N 63/02; C12R 1/07

(52) U.S. Cl. CPC A01N 63/02; C12R 1/07

(57) ABSTRACT

A bacillus velezensis and its application in plants is provided. The bacillus velezensis is Bacillus velezensis NSZ-YBGJ0001, and the deposit number is CGMCC No. 14384. The Bacillus velezensis can effectively prevent and control plant diseases, has no harm to the plants itself, and can promote plant growth to some extent. The use of Bacillus velezensis microbial agent can replace or reduce the use of chemical pesticides; it largely protects the ecological environment and the quality and safety of agricultural products.

### RELATED APPLICATIONS

This application claims priority to China Patent Application CN 2017108100139 filed on Sep. 8, 2017, which is specifically incorporated by reference in its entirety herein.

### FIELD

The present invention is related to a Bacillus velezensis strain and its applications in disease prevention of microbial agents and growth promotion of plants.

### BACKGROUND

In recent years, the China's agricultural planting structure has undergone several positive changes and this trend will persist in coming years. The value addition of cash crops and horticultural crops was enriched with the increase in their planting areas. At the same time, there were tremendous changes made in china's plant development models with the increase in protected land production. In addition, the multiple cropping index (MCI), rapid logistics transportation, large-scale socialization, farming operation and other factors brings huge challenges to the control and prevention of the occurrence, spread and epidemic plant diseases. In result, some diseases continue to erupt and some mainstream diseases come year by year, causing serious production safety hazards to the China's agricultural modernization.

At present, the prevention and control of plant diseases in China is still dominated by chemical pesticides. According to the statistical data released by China Pesticide Information Network (CPIN), the total number of registered pesticide products were 34,315 which includes 3,191 related to biological pesticides (including microbial pesticides), whereas the number of microbial pesticides were only 429. The percentage of registered chemical pesticides, biological pesticides and microbial pesticides was 90.7%, 9.3% and 1.25%, respectively. From the production point of view, there are approximately 2232 pesticide production enterprises nationwide, of which 428 are bio-pesticides (excluding antibiotics), accounting for 19.2%, and the total annual output of pesticides in China is about 3.55 million tons. The output range of chemical pesticides and biological pesticides was 3.26 million tons and 0.29 million tons, respectively, which accounts for approximately 91.83 and 8.17% of the total production. The total crop control area in the country is about 6.525 billion acres, of which the area for chemical pesticides and biological pesticides are about 61.25 and 400 million acres, respectively, accounting for 93.87% and 6.13% of the total control area, respectively.

Chemical pesticides have ensured the safety of crop production for a long period of time. However, due to the recent developments, chemical pesticides have shown some major drawbacks. First, the long-term use of chemical pesticides causes serious pest resistance to the host plant, which gradually leads to increase in amount of dosage. Secondly the more serious drawback is, the application of long-term chemicals pesticides affects the quality of agricultural products, production environment and a serious threat to the entire ecosystem. In recent years, there have been many incidents of agricultural product quality safety caused by chemical pesticides. Thirdly, the development cost of chemical pesticides has gradually increased, and the ration of obtaining an effective chemical composition was approximately 20,000 in 1990s and it decreased to 14,000 in the year of 2010. Furthermore, the cost of R&D starting from few million dollars has reached up to 256 million dollars in 2010. The repeated registration of current chemical pesticide products has a serious degree of homogeneity. According to the data released by the Ministry of Agriculture, the average annual registrations of chemical pesticides in 2015 was 55.5 products per active ingredient, while biological pesticides and microbial pesticides were 1/32 and 1/12, respectively.

Microbial pesticides are a major category of pesticides and an important part of biological pesticides. Because of its natural origin, it is natural friendly to the environment, ecology, humans and animals. Microbial pesticides can only control plant diseases and insect pests in long term, but also have a comprehensive effect of promoting plant immunity and growth. Although the targeted and immediate effects of microbial pesticides are relatively weak compared with chemical pesticides, but their potential for development and market prospects are vast in the current and future emphasis on quality and safety, ecological security, and social security.

Bacillus is the most important for research in the field of microbial pesticides. From the perspective of patent applications and authorizations, China has announced a total of 11,942 patents for Bacillus, of which 3,709 were officially authorized. Among them, patents involving Bacillus subtilis, Bacillus megaterium, Bacillus amyloliquefaciens, waxy Bacillus, Bacillus thuringiensis, Bacillus pumilus, Bacillus licheniformis, Bacillus mucilaginosum, etc. occupy most of the studies but there is less research on patents of Bacillus velezensis, with only 4 applications and 2 formal authorizations. China mainly concentrates on Bacillus thuringiensis, Bacillus subtilis, and Bacillus cereus, with a total of 310 products have been registered for preparation and original drugs discovery, of which Bacillus velezensis has not yet officially registered products. In United States, 3 products of Bacillus subtilis strains and 1 Bacillus amyloliquefaciens have been approved by EPA for commercial production and application licenses, later entered into large-scale applications with good sales performance.

Bacillus velezensis is a new species of Bacillus, named by Ruiz-García (2005). This is a new type of biocontrol bacteria gradually increased in recent years. Some researchers have confirmed that the bacteriostatic active substance of the bacterium is a proteinaceous substance. In China, this strain has been found to have antagonistic activity against Verticillium dahlia Kleb, a pathogen of Verticillium dahliae, Alternaria brassicae of Alternaria alternata, and Botrytis cinereapers of Botrytis cinerea. In foreign countries, some researchers have found that the bacterium has a strong antagonistic effect on rice blast fungus and so on.

The present research and development of Bacillus spp. mainly focus on species of Bacillus thuringiensis and Bacillus subtilis. Bacillus velezensis is a new type of potential biocontrol bacteria with relatively few studies in depth. Industrial development and its application in plant disease prevention and other aspects of research need to be further investigated.

### SUMMARY

In response to the existing problems, the present invention will provide a strain of Bacillus velezensis having a broad-spectrum, disease preventing, and life-promoting ability in plants and a microbial agent containing the strain as an active ingredient.

To achieve the above given objectives, the technical solution adopted for is given below:

One of the objectives of the present invention is to provide a strain of Bacillus velezensis having a broad-spectrum application in disease prevention and life promoting properties. The Bacillus velezensis used in present research is Bacillus velezensis NSZ-YBGJ0001, which was deposited in China General Microbiological Culture Collection Management Center (CGMCC) on Jul. 4, 2017. The deposit ID is CGMCC No. 14384. Bacillus velezensis (NSZ-YBGJ0001 CGMCC No. 14384) was isolated from the soil of Lingshui County, Sanya, Hainan, China.

The second objective of the present study is to provide a Bacillus velezensis microbial agent with broad-spectrum applications in disease prevention and life promoting properties. The Bacillus velezensis NSZ-YBGJ0001 CGMCC No. 14384 is an active ingredient of Bacillus velezensis microbial inoculum provided by the present research. The present application also protects the use of Bacillus velezensis NSZ-YBGJ0001 CGMCC No. 14384 in inhibiting phytopathogenic fungi and pathogenic nematodes, protecting the plants themselves, and promoting growth.

The experimental results showed that Bacillus velezensis (NSZ-YBGJ0001 CGMCC No. 14384) had antagonistic effects on 10 plants pathogenic fungi and 1 plant pathogenic nematode in 8 genera. Among them, soil-borne disease causing, Fusarium oxysporum, Fusarium solani, Verticillium dahlia and Rhizoctonia solani, Sclerotinia sclerotiorum and Colletotrichum spp. inhibition rate were 76.86%-96.91%; compared with Pyricularia grisea, Alternaria tenuissima, Monilinia fructicola, and Colletotrichum gloeosporioides inhibition rate was 87.65%-99.75%. The mortality rate of Meloidogyne incongnita is as high as 100% when the fermentation broth is diluted 1-10 times and when diluted 100 times, the mortality rate was 67%. It is a biocontrol strain with broad-spectrum antibacterial activity.

Experimental results show that the effects of Bacillus velezensis (NSZ-YBGJ0001 CGMCC No. 14384) have no pathogenic effects on rice seedlings, wheat seedlings, tomato seedlings, cucumber seedlings, watermelon seedlings, cowpea, rape seedlings, celery seedlings, lettuce seedlings, and mango, orange, pear Tree, peach and apple young shoots. Among them, rice seedlings, tomato seedlings, cucumber seedlings, watermelon seedlings, lettuce seedlings and their roots have a better role in promoting the growth. Whereas, the mango tree, orange tree and peach tree tender stem and leaves also have promoting effect.

### Beneficial Effect

The Bacillus velezensis NSZ-YBGJ0001 CGMCC No. 14384 provided by the present invention can effectively prevent and control plant diseases, has no harm to the plants itself, and can promote plant growth to some extent. The use of Bacillus velezensis in the present research disclosed, it can reduce the use of chemical pesticides. It largely protects the ecological environment and the quality of agricultural products.

The foregoing has outlined rather broadly the features of the present disclosure in order that the detailed description that follows may be better understood. Additional features and advantages of the disclosure will be described hereinafter, which form the subject of the claims.

### BRIEF DESCRIPTION OF THE DRAWINGS

In order that the manner in which the above-recited and other enhancements and objects of the disclosure are obtained, a more particular description of the disclosure briefly described above will be rendered by reference to specific embodiments thereof which are illustrated in the appended drawings. Understanding that these drawings depict only typical embodiments of the disclosure and are therefore not to be considered limiting of its scope, the disclosure will be described with additional specificity and detail through the use of the accompanying drawings in which:

FIGS. 1A-1D show the colony and cell morphology of Bacillus velezensis NSZ-YBGJ0001 CGMCC No. 14384; wherein FIG. 1A is a colony in the petri plate; FIG. 1B is a single colony under 50× microscope image; FIG. 1C is a 30,000 folds scanning electron microscope (SEM) image. FIG. 1D is the 35,000× scanning electron microscope (SEM) image of a single cell morphology.

FIG. 2 shows the 16s rDNA electrophoresis of Bacillus velezensis (NSZ-YBGJ0001 CGMCC No. 14384), the leftmost band is marker; the right 1-10 bands are 16 rDNA repeats.

FIG. 3 shows the phylogenetic tree constructed by software MEGA7.0.

FIGS. 4A-4C show the alignment of the 16S rDNA sequence homology of Bacillus velezensis (NSZ-YBGJ0001 CGMCC No. 14384 with Bacillus velezensis strain NJAU-Z9. Wherein FIG. 4A shows the first section of the alignment; FIG. 4B shows the second section of the alignment; FIG. 4C shows the third section of the alignment.

FIGS. 5A to 5D show the effect of a fermentation broth of Bacillus velezensis NSZ-YBGJ0001 CGMCC No. 14384 against part of the phytopathogenic fungi. Among them, FIG. 5A is an effect chart of Bacillus velezensis NSZ-YBGJ0001 CGMCC No. 14384 and peach brown rot; FIG. 5B is the effect chart of Bacillus velezensis NSZ-YBGJ0001 CGMCC No. 14384 and Colletotrichum gloeosporioides; FIG. 5C is the effect chart of Bacillus velezensis NSZ-YBGJ0001 CGMCC No. 14384 and A. alternate; FIG. 5D is an effect chart of Bacillus velezensis NSZ-YBGJ0001 CGMCC No. 14384 and Fusarium solani.

### DETAILED DESCRIPTION

The particulars shown herein are by way of example and for purposes of illustrative discussion of the preferred embodiments of the present disclosure only and are presented in the cause of providing what is believed to be the most useful and readily understood description of the principles and conceptual aspects of various embodiments of the disclosure. In this regard, no attempt is made to show structural details of the disclosure in more detail than is necessary for the fundamental understanding of the disclosure, the description taken with the drawings making apparent to those skilled in the art how the several forms of the disclosure may be embodied in practice.

The following definitions and explanations are meant and intended to be controlling in any future construction unless clearly and unambiguously modified in the following examples or when application of the meaning renders any construction meaningless or essentially meaningless. In cases where the construction of the term would render it meaningless or essentially meaningless, the definition should be taken from Webster's Dictionary 3^{rd} Edition.

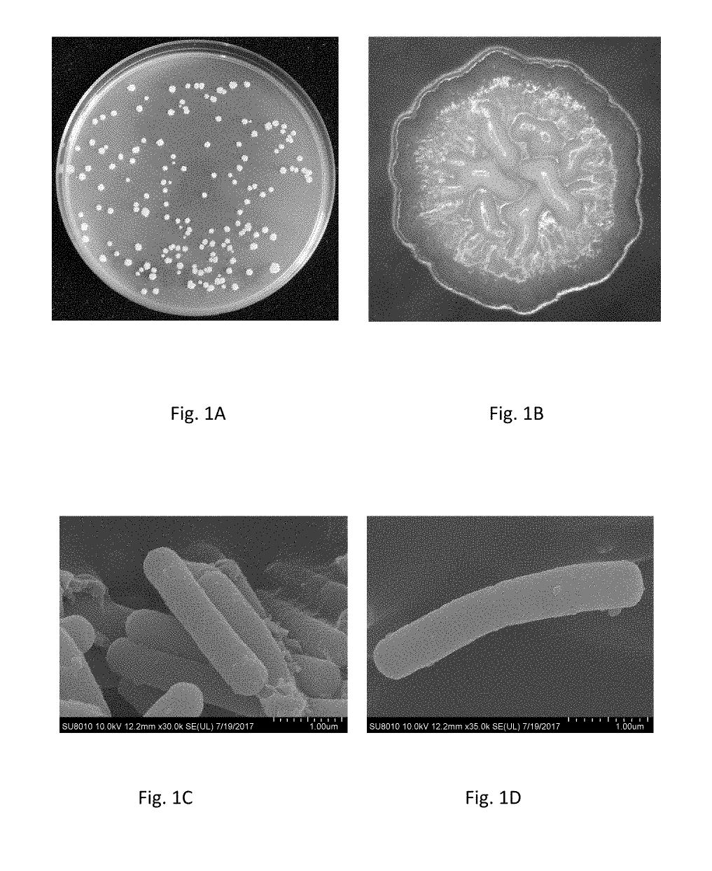

The present invention will be further described in detail below with reference to the FIGS. 1-5.

The examples are given to illustrate the present invention but is not only limited to the following embodiments.

The experimental methods used for this invention are conventional methods unless any specific instrument specified.

### EXAMPLES

### Example 1: Isolation, Purification and Identification of Bacillus velezensis NSZ-YBGJ0001 CGMCC No. 14384

1. Isolation and Purification Bacillus velezensis NSZ-YBGJ0001 CGMCC No. 14384

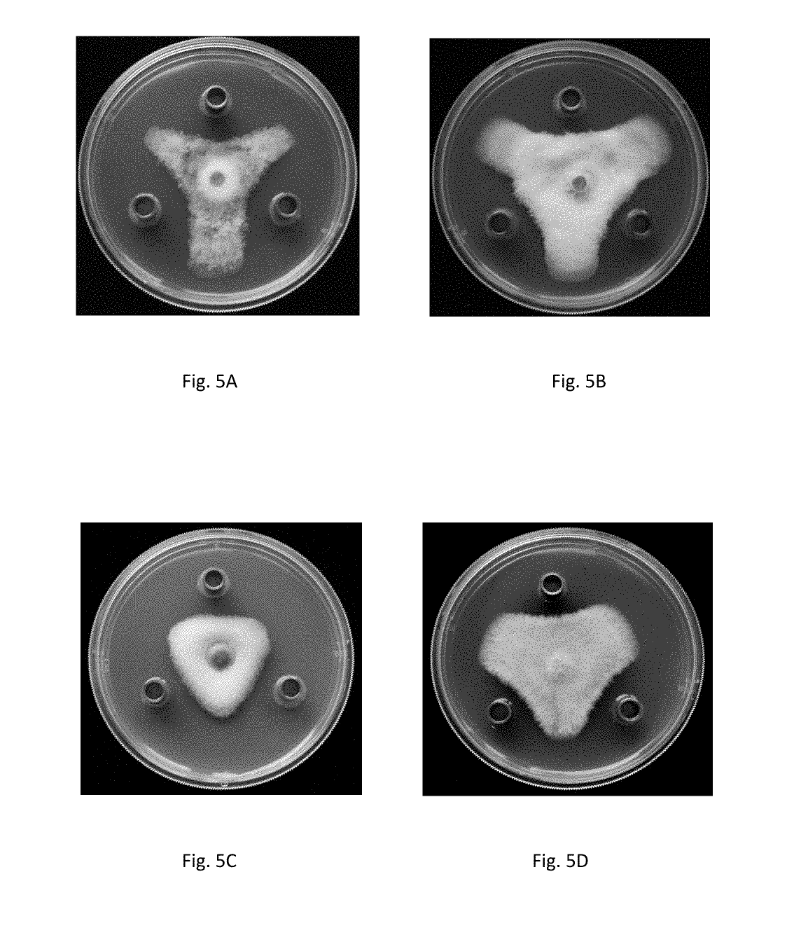

The soil (0.1 g) was collected from cowpea field at Lingshui County, Sanya, Hainan province. Add 0.9 mL sterilized water to soil and shake well to make 10-1 dilution and make successive dilutions of 10-3, 10-4, 10-5 times. Then separately take 0.1 mL from each suspension and apply it evenly on beef extract peptone (NA) medium, repeat each concentration three times and place in an incubator with constant temperature of 28° C. for 24 hours. To grow a single colony, pick a single bacterial colony to obtain a purified bacterial strain. A total of 11 plant pathogens including Fusarium oxysporum, Fusarium solani, Verticillium dahliae, Rhizoctonia solani, Sclerotinia sclerotiorum, Colletotrichum spp., Pyricularia grisea, Alternaria tenuissima, Monilinia fructicola, Colletotrichum gloeosporioides and Meloidogyne incongnita were used for screening of antagonistic strains (FIG. 5). Bacillus velezensis NSZ-YBGJ0001 CGMCC No. 14384 was screened out against the target bacteria.

2. Identification of Bacillus velezensis NSZ-YBGJ0001 CGMCC No. 14384

### I. Morphological Characteristics of Bacteria

Bacillus velezensis NSZ-YBGJ0001 CGMCC No. 14384 placed on NA medium at 28° C. for 20-24 h shows milky white opaque structure with flat, uneven edges and with dull surface (FIGS. 1A,1B), as the culture time increases, the color of the colonies turns to light brown. Rod shaped, gram positive bacterial cells were observed under light microscope. The scanning electron microscope showed that cells were of short rods with a size of 0.5-0.7 μm×2-3 μm. The spores born in the middle have no paracellular cystals (FIGS. 1C, 1D).

### II. Physiological and Biochemical Identification of Strains

Physiological and biochemical tests were performed on Bacillus velezensis NSZ-YBGJ0001 CGMCC No. 14384 are shown in Table 1. Physiological and biochemical traits of NSZ-YBGJ000 were retrieved from the Bergey's Manual of Systematic Bacteriology (9th edition) and Common Bacterial System Identification Manual. The physiological and biochemical characteristics of NSZ-YBGJ0001 are consistent with the corresponding traits of Bacillus velezensis.

TABLE 1
Physiological and Biochemical Identification of NSZ-YBGJ0001

| Project | | Result | Project | | Result |
|---|---|---|---|---|---|
| Catalase | | + | Indole | | + |
| Contact enzyme | | + | V-P test | | − |
| Nitrite reduction | | + | Soluble starch | | + |
| Nitrate reduction | | + | Glucose | | + |
| Propionate | | − | Mannitol | | + |
| Citrate | | + | Sucrose | | − |
| Malonate | | − | Fructose | | + |
| Lecithinase | | − | Glucosamine | | + |
| Urease | | − | Phenylalanine | | − |
| | | | dehydrogenase | | |
| Lipase test | | + | Denitrification test | | − |
| Cellulose degradation | | − | Ammonia production test | | + |
| Methyl red | | − | Heat | −80° C. | + |
| Gelatin liquefaction | | + | tolerance | −20° C. | + |
| State of motion | | − | test | 4° C. | + |
| NaCl | 3% NaCl | + | | 30° C. | + |
| Concentration | 5% NaC | + | | 40° C. | + |
| test | 7% NaCl | + | | 60° C. | + |
| | 10% NaCl | + | | 80° C. | + |
| | 15% NaCl | + | | 100° C. | + |
| | 20% NaCl | + | | 120° C. | − |
| | 30% NaCl | − | | | |

Note:
“+” means positive, “−” means negative.

3. NSZ-YBGJ000 Strain's 16 rDNA Sequence Determination

Pick a small amount of single colony in 50 mL NB medium, place it at 28° C., shake on a 180 rpm shaker for 16 hours, extract the bacterial DNA with bacterial DNA extraction kit and store at −20° C. until use. The 16s rDNA sequence was amplified by PCR with the following primers 27F/1429R.

27F:
5′-AGAGTTTGATCMTGGCTCAG-3′
1492R:
5′-GGTTACCTTGTTACGACTT-3′

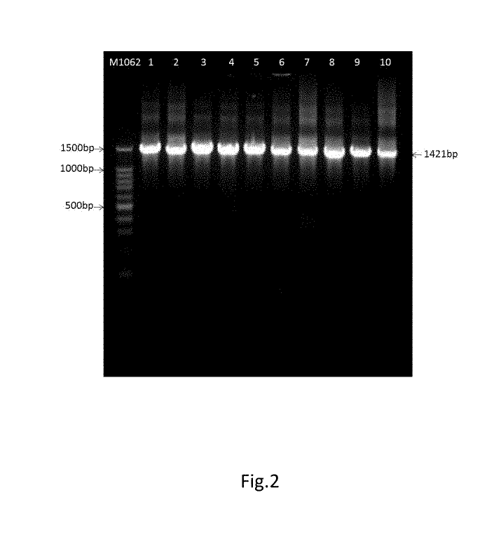

The amplified product was detected by 1.5% agarose gel electrophoresis (FIG. 2). After the successful detection, the fragment was sent to the Shanghai Shenggong Bioengineering service Co., Ltd for two-way sequencing. The 16S rDNA sequence of NSZ-YBGJ0001 strain was 1421 bp (Seq. ID No. 1)

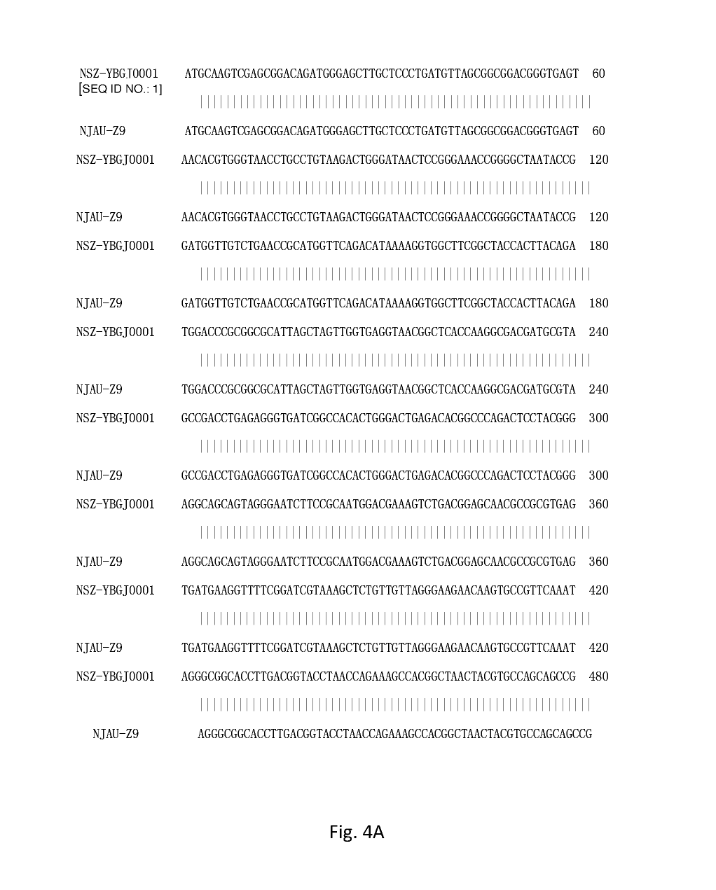

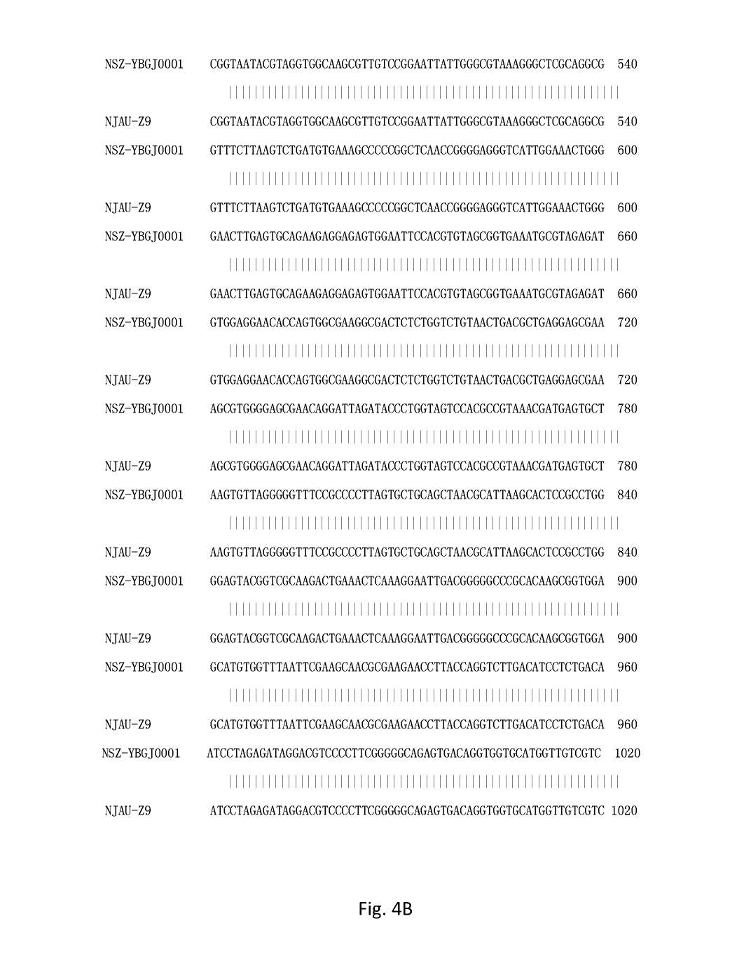

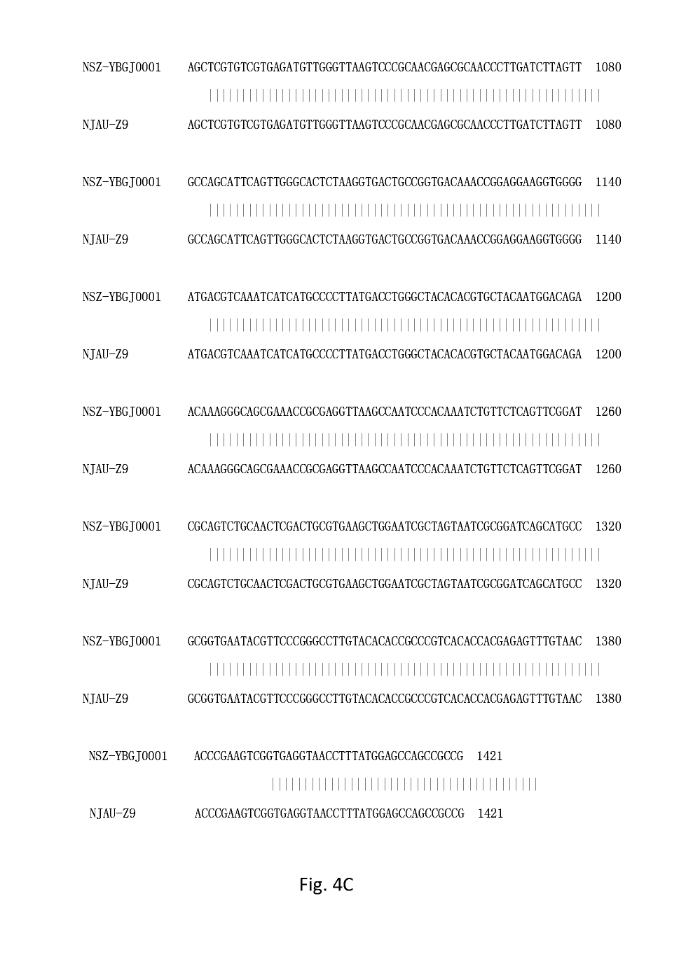

The 16s rDNA sequence of NSZ-YBGJ0001 strain nucleotide sequence is give in list. The homology comparison was performed by NCBI database BLAST. The results showed that the strain NSZ-YBGJ0001 showed 100% similarity with Bacillus velezensis strain NJAU-Z9 (FIGS. 4A-4C).

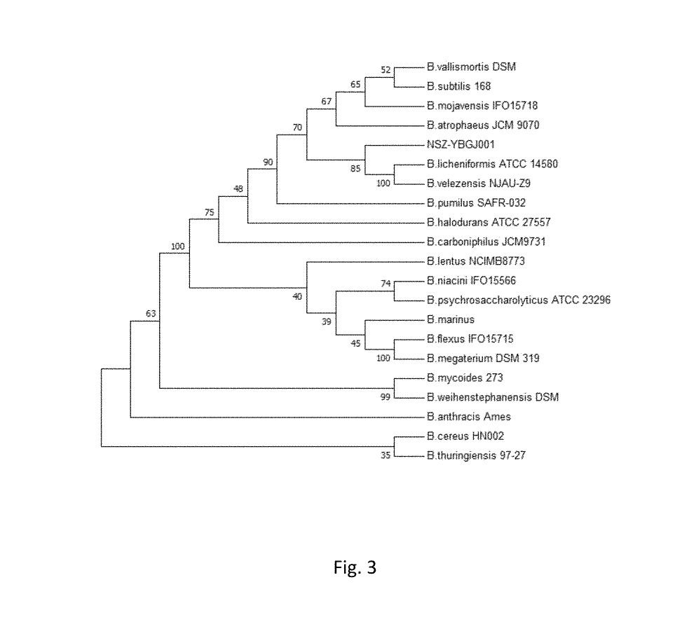

The phylogenetic tree of the 16s rDNA sequence of NSZ-YBGJ0001 strain was constructed with MEGA 7.0 software (FIG. 3). The distance between the NSZ-YBGJ0001 strain and Bacillus velezensis strain NJAU-Z9 was very close.

Combined with the results of morphological, physiological and biochemical characteristics and 16S rDNA sequence homology comparison of the strain NSZ-YBGJ0001 confirmed that this strain is identified as Bacillus velezensis.

### Example 2. The Activity of Bacillus velezensis NSZ-YBGJ0001 CGMCC No. 14384 on Plant Pathogenic Fungi

The inhibitory effects of Bacillus velezensis NSZ-YBGJ0001 CGMCC No. 14384 on phytopathogenic fungi was detected by plate culture method.

The Bacillus velezensis NSZ-YBGJ0001 CGMCC No. 14384 was activated on the NA plate for 24 h. A single colony was picked and inoculated into the NB liquid medium and placed at 28° C. and shaken on a 180 rpm shaker for 16 h. Turbidity determination of bacterial suspension concentration was done with 108 cfu/ml reserve.

The target fungus was cultured on PDA plates at 25° C. for 3-5 days until use. The spare cell broth of Bacillus velezensis NSZ-YBGJ0001 CGMCC No. 14384 was centrifuged and the supernatant was collected. The supernatant was uniformly mixed at a ratio of 1:25 into PDA medium below 50° C., and the plate was ready for use.

Take a spare target fungal plate and use a hole punch (diameter 5 mm) to prepare a fungal cake.

The mycelium was inoculated with mycelia face down in the center of a PDA plate containing the fermentation supernatant of Bacillus velezensis NZZ-YBGJ0001 CGMCC No. 14384.

Each treatment was repeated 4 times, and the diameter of each treated fungal colony was measured after being cultured in the dark at 25° C. for 3 days, 5 days, and 7 days, and the inhibition rate was calculated.

$$inhibition rate ( \% ) = \frac{\begin{matrix}( Colony radius - cake radius ) - \\ ( treated colony dadius - cake radius )\end{matrix}}{( Colony radius - cake radius )}$$

Inhibition of the tested pathogenic fungi by Bacillus velezensis (NSZ-YBGJ0001 CGMCC No. 14384) is shown in Table 2.

In this example, pathogenic fungi from 10 plants including 8 genera were used as target bacteria to determine the antibacterial effect of Bacillus velezensis NSZ-YBGJ0001 CGMCC No. 14384 (Table 2). The results showed that Bacillus velezensis (NSZ-YBGJ0001 CGMCC No. 14384) had obvious antagonistic effects on the tested target pathogens and inhibited their growth. It shows that Bacillus velezensis NSZ-YBGJ0001 CGMCC No. 14384 has strong antibacterial activity and broad spectrum of inhibition.

TABLE 2
Inhibitory effects of NSZ-YBGJ0001 on tested pathogenic fungi.

| | Plate culture method | | Antibac- |
|---|---|---|---|
| | (Colony radius cm) | | terial rate |
| Test strain | CK | NSZ-YBGJ0001 | (%) |
| Fusarium oxysporum | 3.88 | 1.09 | 76.86 |
| Fusarium solani | 3.93 | 0.76 | 86.14 |
| Verticillium dahliae | 4.13 | 0.37 | 96.91 |
| Rhizoctonia solani | 4.19 | 0.49 | 93.91 |
| Sclerotinia sclerotiorum | 4.18 | 1.02 | 80.41 |
| Colletotrichum spp. | 4.1 | 1.15 | 76.62 |
| Pyricularia grisea | 4.3 | 0.26 | 99.75 |
| Alternaria tenuissima | 4.18 | 0.31 | 98.47 |
| Monilinia fructicola | 4.31 | 0.58 | 91.87 |
| Colletotrichum gloeosporioides | 4.3 | 0.75 | 87.65 |

### Example 3: The Activity of Bacillus velezensis NSZ-YBGJ0001 CGMCC No. 14384 on Meloidogyne incognita

Bacillus velezensis (NSZ-YBGJ0001 CGMCC No. 14384) was activated on NA plates for 24 h. Single colonies were picked and inoculated into NA liquid medium. The samples were incubated at 28° C. and shaken on a 180 rpm shaker for 16 h. The bacterial suspension concentration was determined to be 108 cfu/mL.

In a 24-well plate, add 1 mL nematode suspension (concentration about 300 heads/mL) in each well. Add the above-mentioned NSZ-YBGJ0001 suspension with the dilutions of 10, 100, 1000, 5000, 10000 times (NSZ-YBGJ0001 dilution). Now the concentration of NSZ-YBGJ0001 in each treatment was 10⁷ cfu/mL, 10⁶ cfu/mL, 10⁵ cfu/mL, 0.5×10⁵ cfu/mL, 10⁸ cfu/mL, 10⁴ cfu/mL.

The same volume of NA medium dilution was added as a control, and each treatment was repeated 3 times.

The 24 well plates were placed in a dark incubator at 25° C. for 24 h. The total number of root knot nematodes in each well were counted, and the mortality rate of root knot nematodes was calculated.

$$Mortality rate ( \% ) = \frac{Number of dead nematodes}{Number of nematodes introdued} \times 100 \%$$

$$Standardized mortality rate ( \% ) = \frac{( Treatment mortality - Control mortality )}{( 1 - control mortality )} \times 100 \%$$

In this example, Meloidogyne incongnita, one of the most important plant pathogenic nematodes, was used as a target bacterium and the inhibitory effect of Bacillus velezensis NSZ-YBGJ0001 CGMCC No. 14384 on it was determined. The results showed that Bacillus velezensis NSZ-YBGJ0001 CGMCC No. 14384 had a significant inhibitory activity against Meloidogyne incognita (Table 3).

TABLE 3
Inhibitory effects of NSZ-YBGJ0001 on Meloidogyne incongnita

| Concentration of | NSZ-YBGJ0001 | NA diluted | Standardized |
|---|---|---|---|
| bacterial solution | Mortality rate | Mortality rate | mortality rate |
| (cfu/mL) | (%) | (%) | %) |
| 10⁸ | 100 | 3 | 100 |
| 10⁷ | 100 | 4 | 100 |
| 10⁶ | 68 | 2 | 67 |
| 10⁵ | 31 | 2 | 30 |
| 0.5 × 10⁵ | 12 | 3 | 9 |
| 10⁴ | 5 | 3 | 2 |

### Example 4: Determination of Plant Safety and Proliferative Activity by Bacillus velezensis NSZ-YBGJ0001 CGMCC No. 14384

First, the safety of seedlings was tested. Rice, wheat, tomato, cucumber, watermelon, cowpea, rapeseed celery and lettuce seeds were treated with 108 cfu/mL Bacillus velezensis NSZ-YBGJ0001 CGMCC No. 14384 and observe the normal seed germination rate and germination potential. The results showed that Bacillus velezensis NSZ-YBGJ0001 CGMCC No. 14384 had no pathogenicity to the seed germination of the above 9 crops; at the same time, in addition to the watermelon, celery and lettuce seeds, the remaining crops were compared with the control. The seed germination rate and germination power were better than the control, but there was no significant difference.

TABLE 4
NSZ-YBGJ0001 Determination of the Safety and Promotivity of Several Crop Seedlings

| | | | | NSZ-YBGJ0001 | | | Effects on seedlings | | |
|---|---|---|---|---|---|---|---|---|---|
| | Control (%) | | | treatment (%) | | | (%) | | |
| | Germination | Germination | Germination | Germination | Germination | Germination | Germination | Germination | Germination |
| Seed | onset | potential | rate | onset | potential | rate | onset | potential | rate |
| Rice | 0 | 79 | 90 | 0 | 80 | 91 | 0 | 1.27 | 1.11 |
| Wheat | 0 | 85 | 95 | 0 | 88 | 96 | 0 | 3.53 | 1.05 |
| Tomato | 0 | 76 | 92 | 0 | 81 | 93 | 0 | 6.58 | 1.09 |
| Cucumber | 0 | 91 | 99 | 0 | 95 | 99 | 0 | 4.40 | 0.00 |
| Watermelon | 0 | 86 | 91 | 0 | 88 | 90 | 0 | 2.33 | −1.10 |
| Cowpea | 0 | 92 | 97 | 0 | 95 | 98 | 0 | 3.26 | 1.03 |
| Rape | 0 | 95 | 99 | 0 | 97 | 99 | 0 | 2.11 | 0.00 |
| Celery | 0 | 71 | 85 | 0 | 70 | 89 | 0 | −1.41 | 4.71 |
| Lettuce | 0 | 77 | 89 | 0 | 75 | 90 | 0 | −2.60 | 1.12 |

Next, the safety of the plant stems and leaves was examined with leaf inoculation. The mango, orange pear, peach and apple trees were inoculated with Bacillus velezensis NSZ-YBGJ0001 CGMCC No. 14384 in a concentration of 108 cfu/mL. The trees were observed for the occurrence young stems and leaves. The results showed that Bacillus velezensis NSZ-YBGJ0001 CGMCC No. 14384 had no pathogenicity to young shoots and leaves of the above five plants. Moreover, compared with the control, the young stems and leaves of mangoes and oranges were significantly superior to the control.

TABLE 5
NSZ-YBGJ0001 Determination of the Safety and Promotivity
of Stem and Leaf of Several Plants

| | Control | NSZ-YBGJ0001 treatment | |
|---|---|---|---|
| Plant | Incidence | Incidence | Health promotion |
| Mango | Disease-free | Disease-free | Better than the control |
| orange | Disease-free | Disease-free | Better than the control |
| Pear tree | Disease-free | Disease-free | Same as to control |
| Peach | Disease-free | Disease-free | Same as to control |
| Apple | Disease-free | Disease-free | Same as to control |

All of the compositions and methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and methods and in the steps or in the sequence of steps of the methods described herein without departing from the concept, spirit and scope of the disclosure. More specifically, it will be apparent that certain agents which are both chemically related may be substituted for the agents described herein while the same or similar results would be achieved. All such similar substitutes and modifications apparent to those skilled in the art are deemed to be within the spirit, scope and concept of the disclosure as defined by the appended claims.

What is claimed is:

1. Bacillus velezensis NSZ-YBGJ0001, CGMCC Deposit number: 14384

2. A microbial agent, active ingredient of Bacillus velezensis, NSZ-YBGJ0001 CGMCC No. 14384.

3. Application of Bacillus velezensis (NSZ-YBGJ0001 CGMCC No. 14384) inhibits plant pathogenic fungi, pathogenic nematodes and promote growth.
